(19) United States
(12) Patent Application Publication
(10) Pub. No.: US 2005/0090259 A1
(43) Pub. Date: Apr. 28, 2005

(54) Handoff between a wireless local area network and a cellular communication system

(75) Inventors: Nikhil Jain, San Diego, CA (US); Avneesh Agrawal, San Diego, CA (US)

Correspondence Address: Qualcomm Incorporated;Patents Department, 5775 Morehouse Drive, San Diego, CA, 92121-1714, US

(73) Assignee: QUALCOMM Incorporated

(21) Appl. No.: 10/973,792

(22) Filed: Oct. 25, 2004

Related U.S. Application Data
(60) Provisional application No. 60/514,087, filed on Oct. 24, 2003.

(51) Int. Cl. H04Q 7/20

(52) U.S. Cl. 455/439; 455/436

(57) ABSTRACT

Handoff between a wireless LAN and a cellular communication system is provided. A system is designed to provide nomadic cellular services including voice over I.E.E.E. 802.11. An 802.11 network is used as long as the voice quality is likely to be acceptable. Voice quality is measured and maintained to be at an acceptable level. If voice quality degrades below an acceptable level the design allows seamless call hand-off between the 802.11 and a CDMA 1×RTT network, for example.

### CLAIM OF PRIORITY UNDER 35 U.S.C. §119

The present Application for Patent claims priority to Provisional Application No. 60/514,087 entitled “PROVIDING CELLULAR SERVICE OVER WIRELESS LANS AND 802.11 TO CDMA 2000 1× HANDOFF” filed Oct. 24, 2003, and assigned to the assignee hereof and hereby expressly incorporated by reference herein.

### BACKGROUND

1. Field

This invention generally relates to wireless communications. More particularly, the invention relates to handoff between a relatively fixed wireless system and a cellular communication system.

2. Background

Table 1 summarizes acronyms and abbreviations.

TABLE 1
Acronyms and abbreviations

| | |
|---|---|
| AP | Access Point |
| BS | Base Station |
| CDMA | Code Division Multiple Access |
| ESN | Electronic Serial Number |
| EVRC | Enhanced Variable Rate Codec |
| FA | Foreign Agent |
| FFS | For Further Study |
| GPS | Global Positioning System |
| HLR | Home Location Register |
| HW | Hardware |
| IETF | Internet Engineering Task Force |
| IMSI | International Mobile Subscriber Identity |
| IOS | Inter Operability Specifications |
| IP | Internet Protocol |
| LAN | Local Area Network |
| MAC | Medium Access Control |
| MAD | Mobile Addressed message |
| MGW | Media Gateway |
| MIB | Management Information Base |
| MIN | Mobile Identification Number |
| MIP | Mobile Internet Protocol |
| MO | Mobile Originated |
| MS | Mobile Station |
| MSC | Mobile Switching Center |
| MT | Mobile Terminated |
| NGLAN | Next Generation LAN |
| OAM | Operation Administration Management |
| OAM&P | Operation Administration Management & Provisioning |
| OCS | Obiwan Cellular Server |
| PPP | Point to Point Protocol |
| QoS | Quality of Service |
| RFC | Request For Comments |
| RLP | Radio Link Protocol |
| SGW | Signaling Gateway |
| SNMP | Simple Network Management Protocol |
| SS | Supplementary Service |
| SS7 | Signaling System #7 |
| SW | Software |
| TBD | To Be Done |
| TCP | Transport Control Protocol |
| UDP | User Datagram Protocol |
| VoIP | Voice Over IP |
| VOPS | Voice Optimized Power Save |
| WAN | Wide Area Network |
| WSS | Wireless Soft Switch |

### BRIEF DESCRIPTION OF THE DRAWINGS

FIG. 1 is a general system architecture in accordance with an embodiment;

FIG. 2 shows a Signaling Path and a Protocol Stack in accordance with an embodiment;

FIG. 3 shows a Voice Path and a Protocol Stack in accordance with an embodiment;

FIG. 4 shows a flowchart of the operations involved in inter-AP handoff in accordance with an embodiment;

FIG. 5 shows a handoff execution procedure in accordance with an embodiment;

FIG. 6 shows a sequence of events for the handoff procedure;

FIG. 7 depicts the protocol stack at the wireless terminal before the handoff in accordance with an embodiment; and

FIG. 8 depicts the protocol stack at the wireless terminal after the handoff in accordance with an embodiment.

### DESCRIPTION

In an embodiment, handoff between a wireless LAN and a cellular communication system is provided.

In an embodiment, a system is designed to provide nomadic cellular services including voice over I.E.E.E. 802.11. An 802.11 network is used as long as the voice quality is likely to be acceptable. Voice quality is measured and maintained to be at an acceptable level. In an embodiment, if the voice quality degrades below an acceptable level the design allows seamless call hand-off between the 802.11 and a CDMA 1×RTT network, for example.

The system integrates the user experience such that the user is mostly unaware of the underlying transport used to support cellular services. One of the value-add is to ensure that the user interface (UI) that the user uses remains unchanged when the user moves from a WAN to the LAN.

Key cellular features supported include, but are not limited to:

Voice services using Enhanced Variable Rate Codec (EVRC) (MO and MT)

SMS (MO and MT)

Cellular (CDMA like) Supplementary Services

Idle hand-off between the two air interfaces

Seamless call hand-off from 802.11 and CDMA 1 × RTT

The Obiwan Cellular Server (OCS) is a special kind of BSC that supports the Standard Inter Operability Specifications (IOS) 4.2 A1 and A2 interfaces, for example. The OCS server is deployed in the operator's network and provides the support for a client in a wireless unit to provide cellular services.

A wireless unit can also be called a subscriber station, subscriber unit, mobile station, mobile, remote station, remote terminal, access terminal, user terminal, user agent, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

Architecture

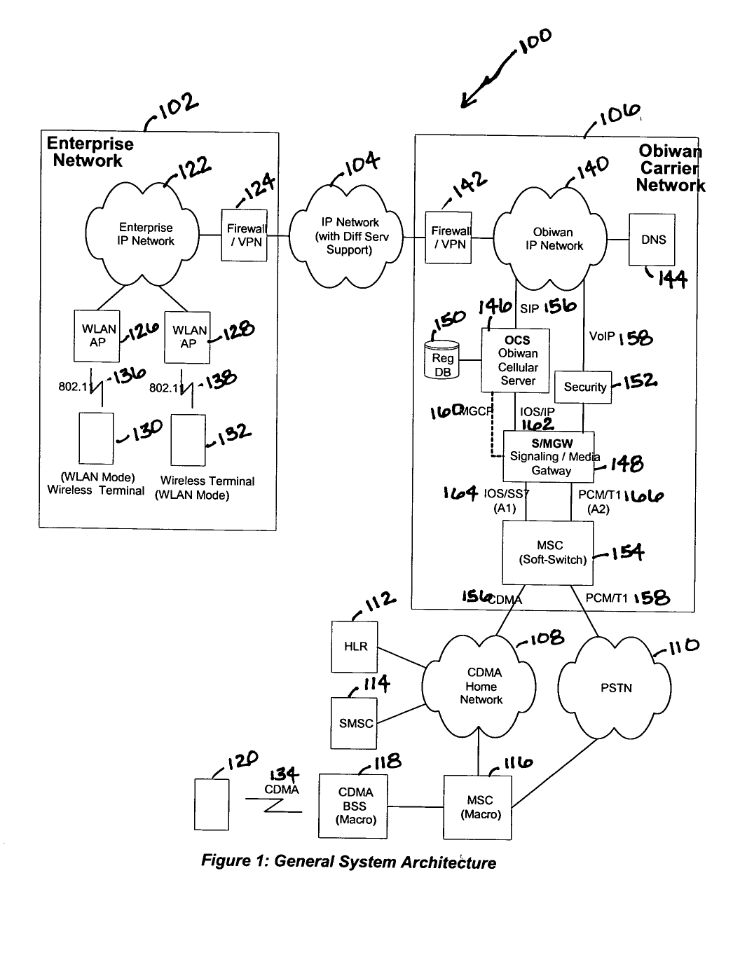

The general system architecture in accordance with an embodiment is shown in FIG. 1. FIG. 1 presents an overall view on a CDMA-WLAN interworking architecture, which enables provisioning of public WLAN access service for the CDMA system subscribers. These enabling functionalities include the reuse of CDMA subscription, system selection, single authentication mechanism, call routing and service access, as well as end user charging. The interworking functionalities are achieved without setting any specific requirements for the WLAN access systems, but relying on the existing functionality available in a typical WLAN access network based on the IEEE 802.11 standard, and introducing the OCS, which acts as a gateway between the standard WLAN system and the CDMA network.

The OCS is responsible of translating between SIP and IOS protocols. It functions as a SIP Server for the wireless unit and as a CDMA BSC for the MSC. A SIP Registrar is used to register users in the SIP/WLAN domain. The SIP Registrar maintains the translation between IMSI/ESN and the IP address for each user in the SIP/WLAN domain.

The media gateway (MGW) and the signaling gateway (SGW) are controlled by the OCS and are used to communicate with the MSC using A1/SS7/T1/E1 for signaling and over A2/T1/E1 for voice transfer. The Signaling Gateway translates between SIGTRAN (IP) and SS7, and the Media Gateway includes vocoders, and it translates between EVRC/RTP and PCM/T1/E1.

The network includes an MSC (Soft-Switch) to provide services to the wireless terminals in SIP/WLAN mode. This MSC supports standard IOS A1 and A2 interfaces towards the OCS/MGW. This MSC is also connected to an IS-41 network for handoffs to the CDMA radio network.

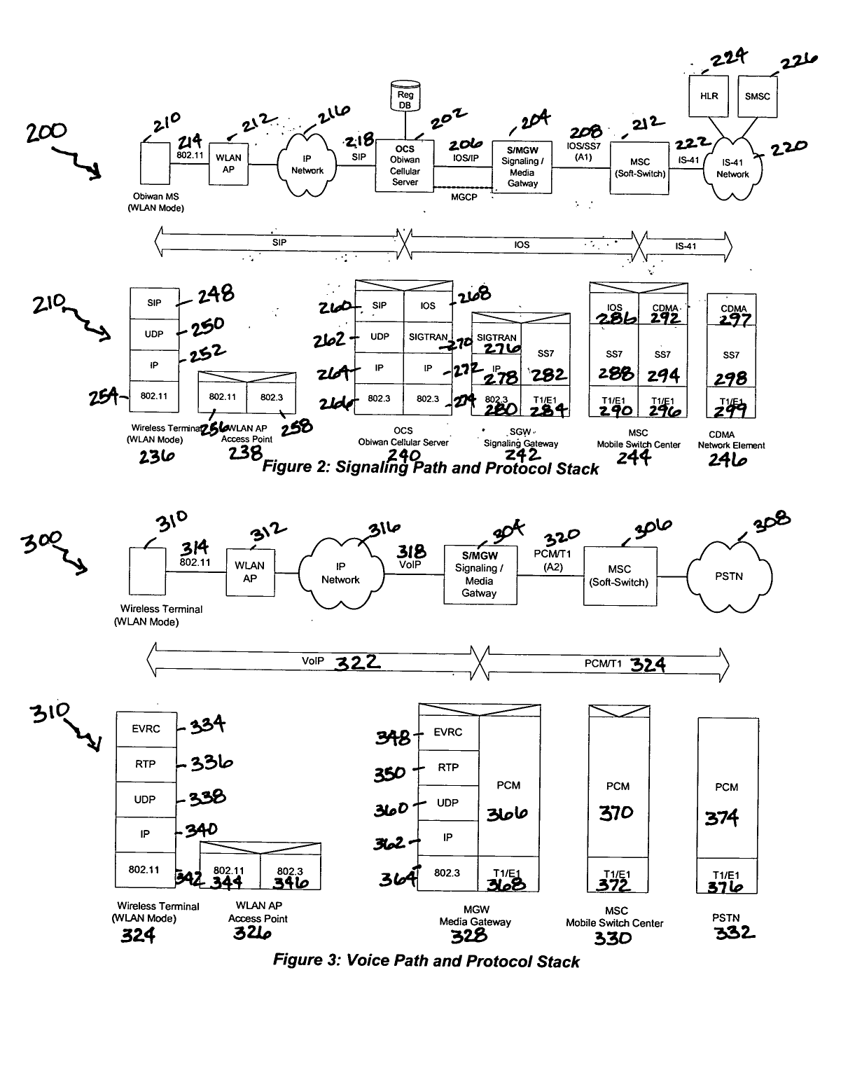

FIG. 2 shows a Signaling Path 200 and Protocol Stack 201 in accordance with an embodiment. FIG. 2 shows the way the OCS 202 (with the SGW) 204 translates between the IOS/IP 206 and the IOS/SS7 protocols 208. The OCS 202 communicates with the wireless device 210 with a SIP/UDP/IP protocol, and with the MSC (SS) 212 using the IOS/SS7 protocol. The wireless device 210 is coupled to a WLAN AP 212 using an 802.11 protocol 214. The WLAN AP 212 is coupled to an IP network 216. The IP network 216 is coupled to the OCS 202 using SIP 218. The MSC (SS) 212 is coupled to a CDMA network 220 using CDMA 222. The CDMA network 222 is coupled to an HLR 224 and an SMSC 226.

The signaling path shows SIP 230, IOS 232, and CDMA 234.

The protocol stacks shown include wireless terminal 236, WLAN AP 238, OCS 240, SGW 242, MSC 244, and CDMA network element 246.

The wireless terminal protocol stack 236 includes SIP 248, UDP 250, IP 252, and 802.11 254. The WLAN AP protocol stack 238 includes 802.11 256 and 802.3 258. The OCS protocol stack 240 includes SIP 260, UDP 262, IP 264, 802.3 266, IOS 268, SIGTRAN 270, IP 272, and 802.3 274. The SGW protocol stack 242 includes SIGTRAN 276, IP 278, 802.3 280, SS7 282, and T1/E1 284. The MSC protocol stack 244 includes IOS 286, SS7 288, T1/E1 290, CDMA 292, SS7 294, T1/E1 296. The CDMA network element protocol stack 246 includes CDMA 297, SS7 298, and T1/E1 299.

FIG. 3 shows a Voice Path 300 and Protocol Stack 301 in accordance with an embodiment.

FIG. 3 shows the way the MGW 304 is used to translate between EVRC and PCM protocols. The wireless terminal exchanges voice packets with the MGW 304 using the EVRS/RTP/UDP/IP protocol, while the MGW 304 exchanges voice frames with the MSC 306 (or PSTN 308) using the PCM/E1/T1 protocol.

The signaling path 300 shows wireless terminal 310 coupled to WLAN AP 312 using 802.11 314. WLAN AP 312 is coupled to EP network 316. IP network 316 is coupled to S/MGW 304 using VoIP 318. S/MGW 304 is coupled to MSC (SS) 306 using PCM/T1(A2) 320.

The signaling path 300 shows VoIP 322 and PCM/T1 324.

The protocol stacks 301 shown include wireless terminal 324, WLAN AP 326, MGW 328, MSC 330, and PSTN 332.

The wireless terminal protocol stack 324 includes EVRC 334, RTP 336, UDP 338, IP 340, and 802.11 342. The WLAN AP protocol stack 326 includes 802.11 344 and 802.3 346. The MGW protocol stack 328 includes EVERC 348, RTP 350, UDP 360, IP 362, 802.3 364, PCM 366, and T1/E1 368. The MSC protocol stack 330 includes PCM 370 and T1/E1 372. The PSTN protocol stack includes PCM 374 and T1/E1 376.

Subscription Management

Primarily the cellular subscription will be used to manage services. This implies that the cellular ESN and IMSI along with AKEY will be used.

An Obiwan capable terminal, when operating in the WLAN environment, will use SIP for call processing signaling. It will tunnel the cellular subscription using SIP signaling infrastructure.

The OCS will store the mapping between the internet address (TCP/IP address and port or UDP/IP address and port) and the cellular subscription in persistent redundant storage.

Handoff Management

Handoff is defined for both active and idle modes. The challenge is to design for all of the various ways that the 802.11 AP's are deployed and maintain performance as the client is used in these 802.11 networks.

Four types of handoff include:

Inter-AP handoff within a WLAN network (talk or idle mode)

WLAN to CDMA handoff (talk or idle mode)

CDMA to WLAN handoff (idle mode only)

Inter-BS handoff within a CDMA network (talk or idle mode)

All four types of handoff are supported in idle mode, and all types of handoff except CDMA to WLAN handoff are supported in talk mode.

Inter-AP Handoff

Inter-AP handoff occurs when the wireless terminal moves from the coverage area of one AP to the coverage area of another AP. The three stages involved in inter-AP handoff are

Handoff trigger: This will occur when the quality of the link between the wireless terminal and the OCS is unsuitable. Note that a trigger does not always result in a handoff, the handoff outcome depends on the search stage. Also, the trigger may result in handoff to a CDMA network, instead of inter-AP handoff.

Search: The wireless terminal will search for new APs, and will select the AP with the strongest signal strength. Handoff will be initiated if this AP is better than the current AP by more than a hysteresis level. (This is to prevent a ping-pong effect). Note that part of the search stage may occur before the handoff trigger, through the construction of a candidate AP list (in cooperation with a database at the OCS).

Completion: The wireless terminal sets up a connection with the new AP. This includes 802.11 authentication, 802.11 association and higher layer functions.

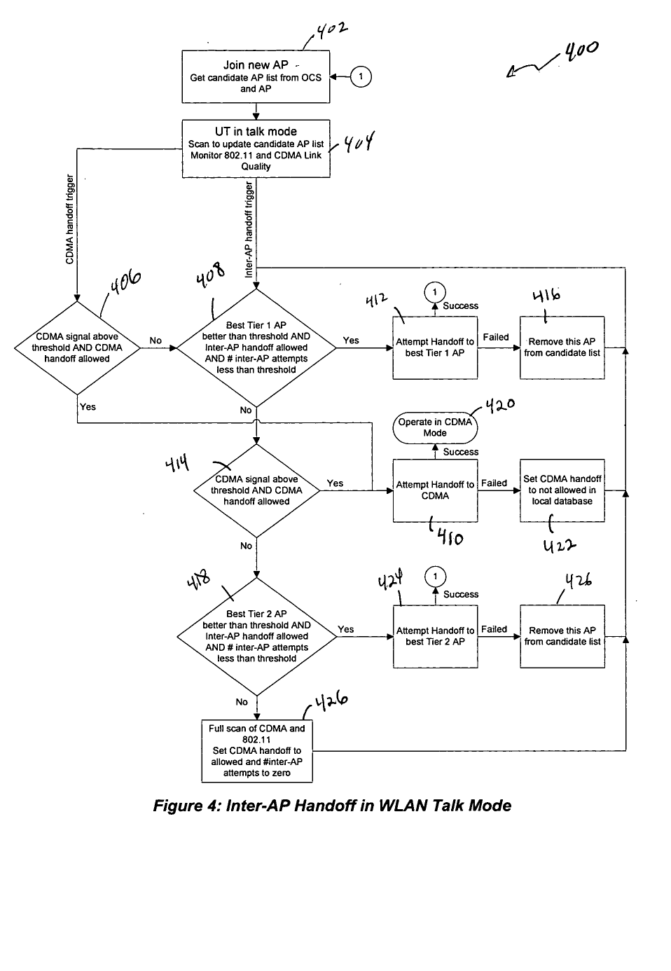

A flowchart of the operations involved in inter-AP handoff in accordance with an embodiment is shown in FIG. 4. In step 402, join new AP. A candidate AP list is obtained from the OCS and AP. In step 404, the wireless terminal is in talk mode. A scan is performed to update the candidate AP list. 802.11 and CDMA link quality are monitored. In step 406 with a CMDDA handoff trigger, a test is made to determine whether a CDMA signal is above a first threshold and CDMA handoff is allowed. If the test fails, then flow of control proceeds to step 408. If the test succeeds, then the flow of control proceeds to step 410.

In step 408, a test is performed to determine whether a best tier 1 AP is better than a second threshold, inter-AP handoff is allowed, and the number of inter-AP attempts is less than a third threshold. If the test succeeds, the flow of control proceeds to step 412, otherwise the flow of control proceeds to step 414.

In step 412, a handoff to the best tier 1 AP is attempted. If the handoff succeeds, then the flow of control proceeds to step 402. If the handoff fails, then the AP is removed from the list in step 416 and the flow of control proceeds to step 408.

In step 414, a test is performed to determine whether a CDMA signal is above a fourth threshold and CDMA handoff is allowed. If the test succeeds, then the flow of control proceeds to step 410. If the test fails, then the flow of control proceeds to step 418.

In step 410 a handoff to CDMA is attempted. If the handoff succeeds, then the wireless terminal operates in CDMA mode in step 420. If the handoff fails, CDMA handoff is set to not allowed in a local database in step 422 and the flow of control proceeds to step 408.

In step 418, a test is performed to determine whether the best tier 2 AP is better than a fifth threshold, inter-AP handoff is allowed, and the number of inter-AP attempts is less than a sixth threshold. If the test succeeds, then the flow of control proceeds to step 424, otherwise the flow of control proceeds to step 426.

In step 426, a full scan of CDMA and 802.11 links is performed. CDMA handoff is set to allowed and the number of inter-AP attempts is set to zero. The flow of control proceeds to step 408.

In step 424, a handoff is attempted to a best tier 2 AP. If the handoff succeeds, then the flow of control proceeds to step 402. If the handoff fails, then the flow of control proceeds to step 426. In step 426, the AP is removed from the list and the flow of control proceeds to step 408.

Inter-AP handoff is mobile controlled as in 802.11 systems (as opposed to the mobile assisted handoff that is commonly used in cellular handovers).

A step in handoff is the generation of a handoff trigger that essentially says that the quality of the current link is unsuitable. Based on the handoff trigger, handoff is executed to a CDMA network or to another AP. The handoff execution itself depends on a list of candidate AP's that is maintained at the wireless terminal. The final step in handoff is the execution of handoff, which involves the setup of a new voice path, and the termination of the old voice path.

Handoff Trigger

The generation of a handoff trigger is governed by different mechanisms depending on whether the wireless terminal is in idle or talk mode.

Handoff Trigger in Talk Mode

Two types of handoff triggers may be generated in WLAN talk mode, inter-AP handoff trigger, and WLAN to CDMA handoff trigger.

An inter-AP handoff trigger is generated when the link quality of the current AP degrades, and there is reason to believe that moving to a different AP improves performance. The communication link comprises the wireless terminal-AP link, and the AP-OCS link. In case the wireless terminal-AP link is degraded, moving to a different AP may result in a better link. The AP-OCS link, however, is likely to be shared among all APs on a network, and degradaion of the AP-OCS link can only be remedied by handoff to a CDMA network. A WLAN to CDMA handoff trigger is generated when the AP-OCS link is degraded, while an inter-AP handoff trigger is generated when the AP-wireless terminal link degrades.

Inter-AP Handoff Trigger

In particular, an inter-AP handoff trigger is generated when either of these conditions are met

Max retry count is reached for upstream transmission.

The data rate reaches the minimum allowed value (1 Mbps). The datarate shifts are according to the following mechanism. A downward rate shift occurs when a frame is retransmitted three times and a request to send/clear to send (RTS/CTS) is used to send the last two retransmissions. A client transmitting at less than the default rate will increase the data rate back to the next-higher rate after a short time interval if transmissions are successful.

The traffic on the downstream (originating at the current AP) is higher than a threshold and either of the following conditions are met.

The downstream vocoder buffer is empty for more than Handoff_Empty_Buffer_Threshold

The upstream buffer contains more than Handoff_Buffer_Threshold packets. A full upstream buffer indicates that packets are not being received successfully by the other party.

The objective here (in case 3) is to distinguish between traffic quality degradation due to queueing at the AP and that due to the internet backbone. If voice packets are received erratically (cases a), or sent erratically (case c) while the traffic is occupied by other packets, the likely cause is heavy traffic at the current AP. This situation can be corrected by moving to a different AP.

WLAN to CDMA Handoff Trigger

A WLAN to CDMA handoff trigger is generated in the following cases.

When 3a or 3b are met, while the downstream traffic is below a threshold (the case where erratic downstream traffic is caused by delay in the internet backbone)

When the RTT between the wireless terminal and the OCS exceeds a certain value for three consecutive measurements. The RTT is measured by special RTT_Request and RTT_Ack packets that are exchanged between the wireless terminal and the OCS periodically.

As shown in FIG. 4, WLAN to CDMA handoff can also take place if inter-AP handoff fails (even when no WLAN to CDMA handoff trigger is generated).

Handoff Trigger in Idle Mode

A handoff pre-trigger is generated in idle mode when any of the following three conditions is met.

Max Retry Count for Keep Alives: When the transmission of a keep alive packet requires more than a certain number of retransmissions, or takes more than a certain amount of time.

Keep Alive Delay: When the response to a keep alive packet is not received within a certain delay period (say 300 ms).

Signal Strength: The signal strength of received beacons or keep alive responses falls below a certain threshold.

Once the handoff pre-trigger is generated, the wireless terminal exits the 802.11 power save mode, and attempts to send keep alive packets in normal operating mode. If the keep alive responses are delayed or have low signal strength, the wireless terminal generates a handoff trigger.

Maintaining a Candidate AP List

Once a handoff trigger is generated, the handoff execution function is called. This function requires as argument a list of candidate APs. In current 802.11 solutions, a scan is performed after the handoff trigger is generated, and the scan results are used to construct a list of candidate APs. For Obiwan in talk mode, however, scanning after a handoff trigger may result in delay and a degradation in voice quality. This section describes some techniques to optimize the scanning function for a wireless terminal in talk mode by gathering information about handoff candidate APs before a handoff trigger is generated.

Note that irrespective of informaiton gathered before the handoff trigger, the wireless terminal always sends a probe to the target AP before it actually associates with it. The objective of optimizing scanning is to maintain a candidate list at the wireless terminal, such that the probe response to the very first AP on the list is successful with high probability.

Candidate AP list

A wireless terminal in WLAN talk or WLAN idle mode maintains a candidate AP list in order to support handoff. In an embodiment, this list comprises the following entries for each candidate AP Y.

MAC address of AP Y

SSID (network identification) of AP Y

Last reported signal strength from AP Y

Inter-AP handoff related metrics

Inter-AP handoff reliability (tier 1 to 4)

Number of successful talk mode handoffs to AP Y

Number of unsuccessful talk mode handoffs to AP Y

Number of successful (but slow) idle mode handoffs to AP Y

Number of successful (and fast) idle mode handoffs to AP Y

Number of unsuccessful inter mode handoffs to AP Y

Call quality history (scale 0 to 7)

IP domain

Security setting (can take either of the following values)

Open (no security)

WEP required (key at OCS)

WEP required (key at wireless terminal, but not available to OCS)

EAP required (key at OCS)

EAP required (key at wireless terminal, but not at OCS)

Handoff Reliability and Security

The reliability metrics is interpreted as follows (subject to security settings).

Level 1: unreliable, Obiwan service not available, never attempt association with AP.

Level 2: marginal. No talk mode inter-AP mode handoff. Idle mode inter-AP handoff only when CDMA not available.

Level 3: moderately reliable. Talk mode inter-AP handoff only when CDMA not available. Idle mode inter-AP handoff irrespective of CDMA signal level.

Level 4: highly reliable. Talk and idle mode inter-AP handoffs even if CDMA signal available.

The ordering of the candidate list is based on the handoff tier and the reported signal strength. First sort the level 4 candidates according to signal strength, and then the level 3 handoff candidates according to signal strength, and so on.

For some deployments, the OCS database may not have the security key that enables the wireless terminal to handoff to the candidate AP. If the AP requires a security key that is not available at either the OCS or at the wireless terminal, the wireless terminal moves the handoff reliability of the AP to level 2.

OCS Database Maintenance

The OCS database initializes the candidate AP list. The OCS database contains an entry of the following form for each AP. The entries include a list of known neighbor AP addresses and some of their properties such as last reported signal strength , call quality history, and security setting, for example.

TABLE 2
OCS Database Record

| | |
|---|---|
| AP MAC ID = 00:02:2D:07:E1:04 | Overall Service Quality = 5 (on a 0 to 7 scale) |

| CDMA cell paramaters | | Signal Strength = 7 (0 to 7 scale) | | Service Parameters (Service | |
|---|---|---|---|---|---|
| | | | | Provider, Base Station ID) | |
| CDMA | Reliability = 1 | # talk success = 8 | # talk fail = 1 | # idle succ = 4 | # idle fail = 0 |
| handoff | | | | | |

| | | | | | | | | | | IP |
|---|---|---|---|---|---|---|---|---|---|---|
| Neighbor | | Call | Inter-AP Handoff | | | | | | | WEP key |
| AP MAC | | Quality | | # Talk | | # Idle | | | | Other |
| ID | Ch | (0-7 scale) | Reliability | S | F | S | Q | F | SSID | security |
| Self ID | 1 | X | 1 | 7 | 3 | 6 | 6 | 3 | QC | 10.30.6/open |
| 00:02:2D:93:B4:3F | 8 | 5 | 1 | 5 | 1 | 2 | 5 | 1 | QC | 10.30.6/open |
| 00:02:2D:1C:C0:27 | 8 | 7 | 2 | 2 | 2 | 4 | 1 | 2 | QC | 10.30.6/WEP |

The entries in the Inter-AP handoff column are described below

Inter-AP handoff reliability (tier 1 to 4)

Number of successful talk mode handoffs to AP Y

Number of unsuccessful talk mode handoffs to AP Y

Number of successful (but slow) idle mode handoffs to AP Y

Number of successful (and quick) idle mode handoffs to AP Y

Number of unsuccessful inter mode handoffs to AP Y

Inter-AP handoff reliability in the OCS database may be different from the reliability in the wireless terminals candidate list (because of security settings).

The entry for the row corresponding to the self ID is constructed as follows. The number of handoffs of different types is simply the sum of the lower rows, while the tier is the minimum of the tiers of all AP's in the record.

The neighbor AP list entries for AP X are updated based on measurement made when the wireless terminal is in WLAN talk or WLAN idle mode, and is associated with AP X. The OCS database is updated every time the wireless terminal communicates one of the following events to the OCS. Note that in the case of dropped connections, this communication may occur minutes or even hours after the event occurred.

The following OCS database events take place to support handoff. These events are in addition to events defined elsewhere in this document.

Record creation: Each time a wireless terminal associates with an AP, it communicates with the OCS

If there is no entry corresponding to AP X, the OCS database creates a new entry. This entry is initialized as:

CDMA_Handoff_Reliabiliy=3

Inter-AP_Handoff_Reliability=3

Overall Service Quality=4

If there is a record in the OCS database, the OCS sends the entry to the wireless terminal, where it is used to form the candidate AP list.

Adding new neighbor AP to record: Each time a wireless terminal detects (during a scan) an AP that is not on the list supplied by the OCS, it requests the OCS to add a new row in the entry for AP X. The call quality and IP domain rows of the entry are filled by looking up the record for AP Y in the OCS database, and if AP Y is not on the OCS database, these are set to detault values Call_Quality_Init and 0.0.0 respectively. The SSID and channel entries are filled using the probe response sent by AP Y. The security settings of the new AP are set accorinding to its SSID. The handoff reliability entries are initialized depending on the SSID of the new AP.

If the new AP has the same SSID as AP X, its handoff reliability is set to 4.

If this new AP has a different SSID, its handoff reliability is set to 3.

Successful talk mode handoff to AP Y: Revise the handoff history entries for the row corresponding to AP Y. Increase handoff reliability by 1.

Successful idle mode handoff to AP Y: Revise the handoff history entries for the row corresponding to AP Y. There can be two types of successful idle mode handoffs, quick and slow.

Quick: If the number of quick idle mode handoffs crosses a number divisible by two, increase the handoff reliability by one.

Slow: If the number of slow idle mode handoffs crosses a number divisible by five, increase the handoff reliability by one, but do not increase beyond 3.

Unsuccessful talk mode handoff to AP Y: Revise the handoff history entries for the row corresponding to AP Y. If the number of unsuccessful talk mode handoffs crosses a number divisible by two, decrease the handoff reliability by one.

Unsuccessful idle mode handoff to AP Y: Revise the handoff history entries for the row corresponding to AP Y. If the number of unsuccessful idle mode handoffs crosses a number divisible by four, decrease the handoff reliability by one.

Successful handoff to a CDMA network: Revise the CDMA handoff history, and increment the CDMA handoff reliability by one.

Unsuccessful handoff to a CDMA network: Revise the CDMA handoff history, and decrease the CDMA handoff reliability by one.

802.11 Scanning Basics

The 802.11 standard defines a scan mechanism to carry out a search for candidate AP's for handoff. For each channel that is to be scanned, the wireless terminal performs the following operations

Move transceiver to desired frequency (assume 1 ms delay)

Set backoff window to ProbeDelay duration (typical 100 μs), and NAV vector to zero. Begin normal DCF operation.

If channel not free during ProbeDelay, set NAV according according to current transmission.

Transmit probe packet (packet duration about 250 μs)

Wait for response to probe packet (observed delay about 1 ms)

Probe packets can be of two types: broadcast or unicast. A broadcast probe has destination address ff:ff:ff:ff:ff:ff, and any AP may respond to it. A unicast probe has a specific destination address, and only the AP with the destination address of the probe packet responds to a unicast probe.

Continuously Updated Candidate AP List

In order to provide fast handoff, continuous active scanning is supported while in talk mode in accordance with an embodiment. When continuous updates are used, every ScanInterval seconds (say 1 sec), a wireless terminal in talk mode scans one channel. If possible, the scanning operation commences immediately after a packet has been received on the downstream (to prevent a downstream packet from being missed while the wireless terminal is scanning another channel). The scan results are used to build a handoff candidate list which will be used in case the link to the current AP degrades.

In an embodiment, channel scanning and handoff candidate list update follows these rules:

The handoff candidate list is sorted based on the entries for each candidate. Thus, the handoff candidate list may be sorted in part based on the call quality history, for example.

Every second (2nd) probe is sent on the channel of the AP on top of the handoff candidate list.

Other probes cycle through all channels contained in the handoff candidate list.

After every Scan_Other_Channels seconds, the wireless terminal scans (subject to rule 2) channels not contained in the handoff candidate list.

Each probe response is used to update the handoff candidate list (in particular the last observed signal strength field)

If a new AP is detected during a scan, the OCS database is notified.

In experimental results it has been found that a channel scan (probe and response operation) requires about 2 ms. Assuming that the time taken to switch channels is 1 ms, a wireless terminal in talk mode can scan a channel and return to the original channel in about 4 ms. This time does not include the time taken by the MAC hardware to switch into scan mode. One of the recommendations for an 802.11 chipset is that it allow for quick scanning.

The scan procedure in idle mode is different. Every Idle_Mode_Scan_Interval seconds, the wireless terminal conducts a full channel scan. This scan is used to update the OCS database, but the candidate AP list shall not be used in idle mode. Instead, a full channel scan is conducted before handoff.

Handoff Execution

Talk Mode Handoff Execution: Based on entries for each candidate, the candidate AP list is sorted. If the signal strength of the AP on top of the list is sufficient, handoff is attempted to the AP on top of the list. If handoff fails, the wireless terminal tries to link with the next AP on the candidate list, and continues this process until a timer expires, or a maximum number of handoff attempts have been made. See FIG. 4 for details.

Idle Mode Handoff Execution: The wireless terminal exits the 802.11 power save mode, and scans all channels valid for the operating regulatory domain to construct a candidate AP list, and sorts the list according to the rules given in 0. If handoff fails, the wireless terminal tries to link with the next AP on the candidate list, and continues this process until a timer expires, or a maximum number of handoff attempts have been made. The wireless terminal sends a keep alive upon completing every handoff. This keep alive includes the time taken for handoff completion, and is used by the OCS to refresh its database. After handoff is complete (successful exchange of messages with the OCS), the wireless terminal switches back to 802.11 power save mode. The exact mechanism for handoff depends on the level of security implemented in a WLAN deployment.

Handoff with No Security

First consider the simplest case, where no security settings or only WEP security settings are used. For these simple cases the process of handoff comprises the following steps

Send authentication request, get authentication response. This is the stage where the WEP key, if assigned, is used. A wireless terminal gets the WEP key from the OCS database or a local database at the wireless terminal.

Send association request, get association response.

Use inter-AP protocol to inform old AP to remove wireless terminal from its list

Use SNAP to inform the switch at the AP subnet to send packets for wireless terminal to the new AP

Handoff with Security

Security is implemented using the 802.1× standard that specifies the operation of EAP (extended authentication protocol) over 802 networks.

802.11 to 1× Handoff in Voice Mode

An active state handoff features a handoff from 802.11 operation mode to native 1×RTT mode.

Deciding Between Inter-AP and CDMA Handoffs

When the current AP has low signal strength, we need to decide whether to handoff to a CDMA network or WLAN. For example, in a home WLAN (with only one AP), attempting to handoff to an alternate AP will result in additional delay, and handoff to a CDMA network is attempted as soon as the WLAN link degrades in accordance with an embodiment. On the other hand, in an enterprise deployment, there are likely to be many AP's and handoff to an alternate AP should be attempted before handoff to a CDMA network is attempted.

In case scanning performed during the call (or before the call began) indicates that no other AP's are available, the decision between WLAN and CDMA is clear, and handoff must be to CDMA. However, when other AP's are present, we need to decide whether to handoff to WLAN or CDMA. This decision is important because:

Handoff to WLAN Maximizes Free Spectrum Usage

Handoff to WLAN may cause excess delay if a new IP address needs to be obtained or if WLAN deployment results in excessive delay.

The OCS database helps the wireless terminal decide if handoff should be to WLAN or CDMA. Details of this decision process are given in the flowchart in FIG. 4. Talk mode WLAN to CDMA handoff is attempted if there is a trigger for WLAN to CDMA handoff, or if there is no reliability level 4 AP with signal strength above a threshold.

WLAN to CDMA Handoff Basics

Prior to the handoff, the user terminal employs a SIP over IP over 802.11 protocol stack in the signaling plain, as well as a VoIP stack in the traffic plain. After the handoff procedure is completed, the user terminal employs a native IS-2000 1×RTT signaling protocol stack in the signaling plain, as well as a native IS-2000 1×RTT voice processing at the traffic plain.

The target CDMA BTS, target CDMA BSC and target IS-41 MSC are standard components. The OCS interaction with the IS-41 MSC throughout the handoff procedure complies with the IS-41 and IOS specifications. Development is only allowed and required at the OCS and at the user terminal.

During a voice call in 802.11 operation mode, the wireless terminal should monitor both networks (802.11, CDMA). If the reception power of the 802.11 falls below a certain threshold, the wireless terminal should report the reception power of both networks to the OCS. The OCS may then invoke intersystem handoff procedure to CDMA. Hence, this handoff procedure is mobile assisted. As part of this procedure, the OCS should forward the Handover Command that is received from the IS-41 MSC to the user terminal. The user terminal should then terminate its operation in 802.11 operation mode, tune to 1×RTT mode, kick start its CDMA protocol stack into Active mode and perform the standard CDMA handoff sequence together with the target base station.

Handoff Trigger

Handoff from WLAN to CDMA can occur in two cases: when there is a trigger for WLAN to CDMA handoff, or when inter-AP handoff fails, resulting in a request for handoff to a CDMA network (see details in FIG. 4).

The trigger for WLAN to CDMA handoff is generated when any of the following conditions are met.

No packets are received on the downlink for Handoff_Timeout_Threshold

The fraction of missed packets on the downstream exceeds Handoff_PacketLoss_Threshold.

Separate RF chain and firmware will be used by the user terminal for each operation mode (802.11, CDMA). During an 802.11 call, the user terminal should periodically monitor both the 802.11 and the CDMA networks, using the separated hardware. The wireless terminal should attempt to acquire the Pilot Channel of a CDMA system. Following the first Pilot channel acquisition, the wireless terminal should also acquire the associated Synch and Paging channels, to obtain timing information, SID and NID pair, Neighbor List message and the BASE_ID for the CDMA system. Subsequently, the wireless terminal should remain in a reduced flavor of the CDMA Idle state with Slot Cycle Index zero and perform idle mode handoffs to the neighbor cells when needed. The wireless terminal should maintain a list of the 4 strongest Pilot channels received and their associated PN offset, receive power and BASE_ID.

The OCS may reside in a distant location than the target CDMA cell for the handoff. As a result and unlike native CDMA, the OCS is unable to determine the unique identification of the target CDMA cell, based on PN offset alone. The wireless terminal should therefore acquire the Paging channel of the target cell and obtain the BASE_ID from the System Parameters message. To reuse standard CDMA design and implementation, the wireless terminal should remain in the flavor of the idle state mentioned above. This may cause a small waste of battery consumption, but simplifies the implementation significantly.

The user terminal should also monitor the reception power and rate of the 802.11 mode. In case the reception power of the 802.11 network falls below a predefined threshold, the user terminal should send a PSMM-like signaling message to the OCS, to report the receive power of both networks. The PSMM-like signaling message should contain the SID and NID of the CDMA system, the BASE_ID for the reported cells and their receive power. Based on this measurements report, the OCS may invoke an intersystem handoff procedure to CDMA.

Handoff Execution

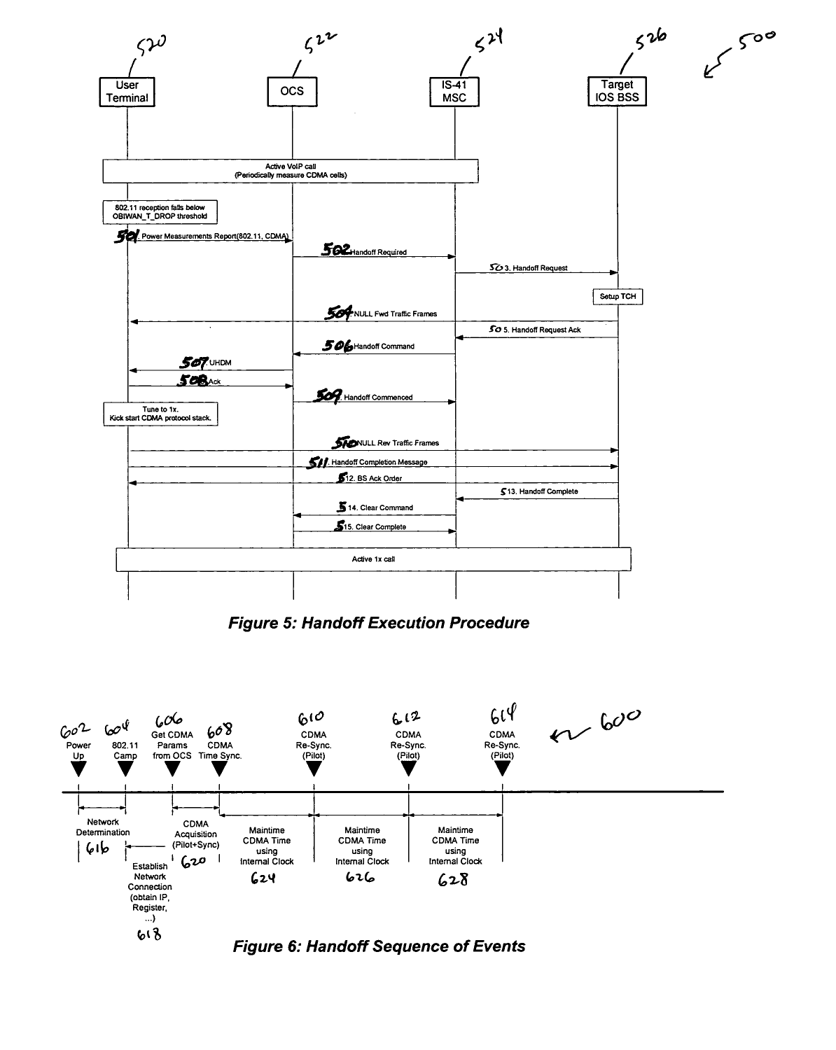

If the OCS determines to invoke the inter system handoff procedure to CDMA, the procedure depicted in FIG. 5 is executed by the system.

In step 501, the wireless terminal has detected that the receive power of the 802.11 system falls below a predefined threshold. As a result, the wireless terminal sends a power measurement report signaling message to the OCS, tunneled over the 802.11 network. This massage contains measurement of the receive power of both the 802.11 and the CDMA networks.

In step 502, based on a wireless terminal report that it has crossed a network specified threshold for signal strength, the OCS recommends a hard handoff to a CDMA network. The OCS sends an IOS Handoff Required message to the target IS-41 MSC to find a target with available resources.

In step 503, the target IS-41 MSC sends a Handover Request message to the target IOS BSS, requesting the BSS to prepare resources for the forthcoming handoff.

In step 504, the target BSS determines that appropriate resources are available and starts transmitting forward NULL traffic data.

In step 505, the target BSS sends a Handoff Request Acknowledge message to the MSC.

In step 506, the MSC prepares to switch from the OCS to the target BSS and sends a Handoff Command to the OCS to convey information from the target BSS.

In step 507, the OCS sends the Universal Handoff Direction Message to the wireless terminal and may request an acknowledgment. These messages are tunneled over the 802.11 network.

In step 508, the wireless terminal returns an acknowledgment to the OCS to confirm receipt of the Universal Handoff Direction Message.

In step 509, the OCS sends a Handoff Commenced message to the MSC to notify it that the MS has been ordered to move to the target BSS.

In step 510, the wireless terminal tunes to CDMA mode and kick start its protocol stack to Active call state. The wireless terminal then tunes to its allocated traffic channel and starts transmitting reverse NULL traffic data. Protocol stack initialization at the wireless terminal is further described below.

In step 511, the wireless terminal sends a Handoff Completion Message to the target BSS.

In step 512, the target BSS sends the BSS Ack Order to the wireless terminal over the air interface.

In step 513, the target BSS sends a Handoff Complete message to the MSC to notify it that the wireless terminal has successfully completed the hard handoff.

In step 514, the MSC sends a Clear Command to the OCS.

In step 515, the OCS sends a Clear Complete message to the MSC to notify it that clearing has been accomplished.

The overall sequence of events for the handoff procedure is depicted in FIG. 6.

CDMA Protocol Initialization at the User Terminal

In order to carry out the handoff, the wireless terminal needs to replace its operational protocol stack from 802.11 prior to the handoff, to CDMA after the handoff. Furthermore, the CDMA protocol stack needs to be kick-started directly into its Active call state. In native CDMA operation, the CDMA protocol stack performs state transitions from NULL state to Idle state and then to Active call state. These state transitions are accompanied by considerable interaction with the network, like the exchange of signaling messages as well as equivalent state transitions at the peer entities at the network. Conversely, in the 802.11 to CDMA handoff scenario, the CDMA protocol stack is initialized locally at user terminal, directly into Active call state. This can be done, for example, by the introduction of a handoff agent in the wireless terminal software, which will play a set of primitives to the CDMA protocol stack to locally drive the required state transitions. After the CDMA protocol stack enters the Active call state, the handoff agent can deliver the Handover Command signaling message received from the OCS to the CDMA protocol stack. The CDMA protocol stack can then perform the standard CDMA handover sequence with the target BSS.

All the above processing should be hidden from the user (within reason) and has to meet strict time constraints.

The design approach for the wireless terminal software should use existing AMSS features and API wherever possible and to introduce code changes where needed.

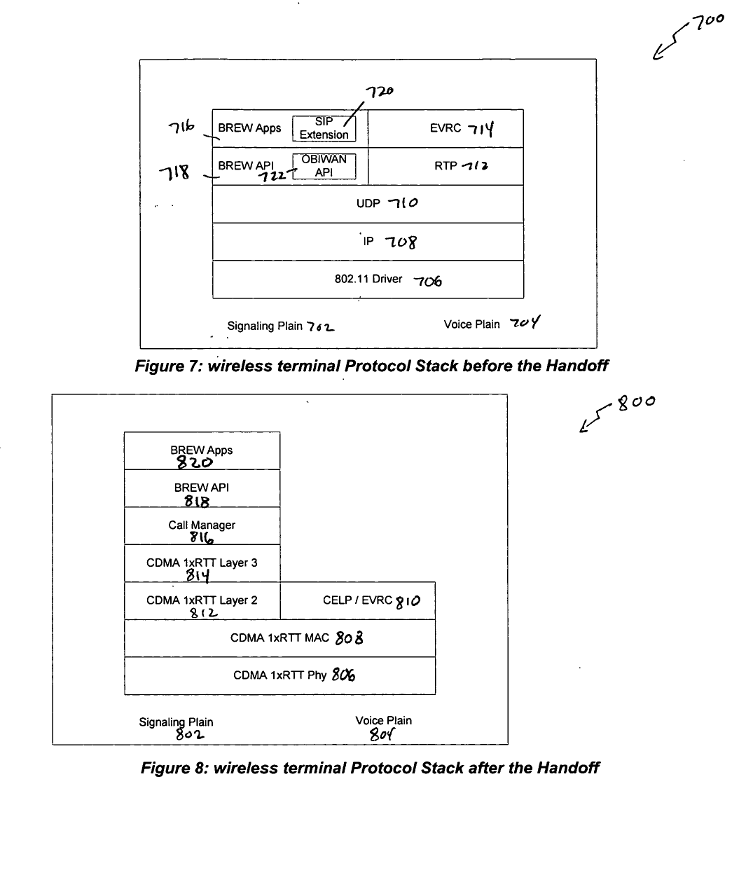

FIG. 7 depicts the protocol stack at the wireless terminal before the handoff.

FIG. 8 depicts the protocol stack at the wireless terminal after the handoff.

1× to 802.11 Handoff in Idle Mode Only

In an embodiment, handoff from 1× to 802.11 is supported in idle mode only. While in 1× idle mode, the wireless terminal periodically scans for energy on all 802.11 channels. If the energy from an AP is high, the wireless terminal attempts to authenticate itself with that AP. It can use the data channel of 1× to communicate with the OCS to get the appropriate keys to access the 802.11 network. Once the wireless terminal is associated with the AP, it will register with the network (MSC).

Inter-BS Handoff in CDMA Mode

Inter-BS handoff in CDMA mode is completely independent of LAN operation.

This invention provides cellular voice and data service over WLANs. The invention also provides integrated cellular service with NGLAN stems from billing and distribution. This mitigates the difficult coverage and deployment issues by providing appropriate core network integration. Also, the system is backward compatible with 802.11.

Single number/Two networks. Cellular number works on either the 1× network or NGLAN. The core network recognizes whether to deliver service to 1× or NGLAN. Handoffs in the idle mode moves between networks and the core network delivers it to the mobile. 1× handoffs handle the active support of NGLAN.

Service Integration

Cellular service is delivered using a 1× system. NGLAN service is delivered using NGLAN. Both can be monitored simultaneously. The outgoing service can be configured to use the preferred access. AKEY, ESN and IMSI are used for authentication. RADIUS is used for data authentication. The billing records are consistent with cellular systems. This system preserves the look and feel with SMSS integration, supplementary service support, seamless service availability and simultaneously monitoring 1× and NGLAN networks.

The system provides the ability to simultaneously monitor the 1× and the NGLAN networks. The handoff trigger and target selection support help to determine if a handoff is needed. In a preferred embodiment, this occurs in about 80 seconds. Additionally, the system determines the target within about 20 milliseconds. The sleep modes between 802.11 and 1× are coordinated and the core BSC development support is integrated.
NGLAN−>1× Handoff

The NGLAN is terminal initiated. The message flows are similar to the ones in CDMA 2000. The messages between the IP-BSC and the clients are tunneled over internet protocol.

1. A method of handoff from a local area network (LAN) to a CDMA network for a wireless terminal, comprising:
determining an access point (AP) candidate list from a plurality of AP's;
sorting the AP candidate list based in part on signal strength of the plurality of AP's;
selecting an AP from the AP candidate list based in part on signal strength of the plurality of AP's;
determining a handoff trigger has been triggered based in part on quality of a wireless terminal link; and
connecting to the selected AP if a handoff trigger occurs and the signal strength of the selected AP is greater than the signal strength of a current AP by a hysteresis level.

2. A wireless terminal, comprising:
means for determining an access point (AP) candidate list from a plurality of AP's;
means for sorting the AP candidate list based in part on signal strength of the plurality of AP's;
means for selecting an AP from the AP candidate list based in part on signal strength of the plurality of AP's;
means for determining a handoff trigger has been triggered based in part on quality of a wireless terminal link; and
means for connecting to the selected AP if a handoff trigger occurs and the signal strength of the selected AP is greater than the signal strength of a current AP by a hysteresis level.

3. Computer readable media embodying a program of instructions executable by a computer program to perform a method of handoff from a local area network (LAN) to a CDMA network for a wireless terminal, comprising:
determining an access point (AP) candidate list from a plurality of AP's;
sorting the AP candidate list based in part on signal strength of the plurality of AP's;
selecting an AP from the AP candidate list based in part on signal strength of the plurality of AP's;
determining a handoff trigger has been triggered based in part on quality of a wireless terminal link; and
connecting to the selected AP if a handoff trigger occurs and the signal strength of the selected AP is greater than the signal strength of a current AP by a hysteresis level.
